(19) United States
(12) Patent Application Publication
(10) Pub. No.: US 2007/0170257 A1
(43) Pub. Date: Jul. 26, 2007

(54) Method and device for determining the authenticity of an object

(76) Inventor: Attila Haraszti, Budapest (HU)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/553,377

(22) PCT Filed: Apr. 29, 2004
(86) PCT No.: PCT/EP04/04539

§ 371 Date: Jul. 10, 2006

(30) Foreign Application Priority Data
Apr. 30, 2003 (EP) 03462003.9
Jan. 30, 2004 (EP) 04462004.5

(51) Int. Cl. G06K 7/10

(52) U.S. Cl. 235/454

(57) ABSTRACT

An authentication method is provided that is based on a reference object, such as an authentication label attached to an optical disc. The authentication label has a three-dimensional distribution of particles. For the purposes of authentication it is determined whether there is in fact a three-dimensional particle distribution. Next a two-dimensional data acquisition step is performed for the purpose of authentication. This method is particularly useful for copy protection.

### FIELD OF THE INVENTION

The present invention relates to the field of authentication techniques, and more particularly without limitation, to authentication of customer cards, financial transaction cards and copy protection.

### BACKGROUND AND PRIOR ART

Various sealing and printing techniques to provide authentication and to avoid unauthorised replication of products and documents are known from the prior art. However, an increasing economic damage results from forgery due to insufficient security.

For authenticating documents and things U.S. Pat. No. 5,145,212 teaches the use of non-continuous reflective holograms or diffraction gratings. Such a hologram or diffraction grating is firmly attached to a surface that contains visual information desired to be protected from alteration. The reflective discontinuous hologram is formed in a pattern that both permits viewing the protected information though it and the viewing of an authenticating image or other light pattern reconstructed from it in reflection. In another specific authentication application of this U.S Patent a non-transparent structure of two side-by-side non-continuous holograms or diffraction patterns, each reconstructing a separate image or other light pattern, increases the difficulty of counterfeiting the structure.

PCT application WO087/07034 described holograms, including diffraction gratings, that reconstruct an image which changes as the hologram is tilted with respect to the viewer and in a manner that images reconstructed from copies made of the hologram in monochromatic light do not have that motion.

In UK Patent Application GB 2 093 404 sheet material items which are subject to counterfeiting have an integral or bonded authenticating device which comprises a substrate having a reflective diffractive structure formed as a relief pattern on a viewable surface thereon and a transparent material covering the structure. Specified grating parameters of the diffractive structure result in peculiar, but easily discernable, optical colour properties that cannot be copied by colour copying machines.

U.S. Pat. No. 4,661,983 described a random-pattern of microscopic lines or cracks having widths in the order of micrometers that inherently forms in a dielectric coating of an authenticating device incorporated in a secure document. It permits identification of a genuine individual document by comparing read-out line-position information derived by microscopic inspection with read-out digital codes of line-information obtained earlier at the time of fabrication of the document.

U.S. Pat. No. 5,856,070 shows an authentication label containing a light diffracting structure. Unique parameters are randomly defined in the light diffracting structure by anisotropic process steps not under full control of the producer during the manufacturing of the diffracting structure to prevent copying or creating an exact replica thereof. The resultant uniquely coloured authenticating pattern can be verified by simple observation with the naked eye.

U.S. Pat. No. 4,218,674 shows an authentication method and system that uses an object being of base material having random imperfections. The random imperfections are converted into pulses along a pre-determined measuring track over the surface of the object of base material. WO01/57831 shows a similar method that uses random gas enclosures in an authentication object.

### SUMMARY OF THE INVENTION

The present invention provides for an authentication method which is based on an authentication object, such as an authentication label, having a three-dimensional pattern of distributed particles. By means of a two-dimensional data acquisition performed on the object a code is obtained that is used for the purpose of authentication.

When the authenticity of the object needs to be checked the same two-dimensional data acquisition step is performed again in order to provide a check-code. On the basis of the code and the check-code the authentication is performed. For example, if the code and the check-code are identical, this means that the object is an original and not an unauthorised copy.

The present invention is particularly advantageous as authentication is based on the three-dimensionality of the particle distribution within the object. If it is determined for the purposes of authentication that an object does in fact have a three-dimensional pattern of distributed particles it is sufficient to perform the consecutive data acquisition in two-dimensions. This approach is based on the discovery that it is most difficult if not impossible to copy the particle distributions in two-dimensions in case the particles are distributed in three-dimensions.

In accordance with a preferred embodiment of the invention the particles that are distributed in the object are magnetic. The two-dimensional data acquisition is performed by scanning the object by means of a magnetic head.

In accordance with a further preferred embodiment of the invention an image of the object is acquired in the two-dimensional data acquisition step. The image is scanned and filtered in order to obtain a data vector. Preferably the filtering involves some kind of averaging in order to increase the robustness of the method.

In accordance with a further preferred embodiment of the invention binary data is encrypted by means of the code acquired from the two-dimensional data acquisition in order to provide a code for the authentication. Preferably the binary data is a symmetric key that is used for encryption and decryption of mass data.

In accordance with a further preferred embodiment of the invention the code acquired from the object by means of the two-dimensional data acquisition is a reference data vector. For encoding of each bit of the binary data a random vector is determined on the basis of the reference data vector. This encryption method is particularly advantageous as the key management problem is avoided. In contrast to prior art encryption it is not performed on the basis of an exact key but on the basis of a reference object from which a reference data vector data is acquired.

In accordance with a further preferred embodiment of the invention a data object is used as a reference object. For acquisition of a reference data vector the data object is rendered by means of a rendering program, such as a text processing program in case the data object is a text document, and the data acquisition is performed on the rendered data object.

In accordance with a further preferred embodiment of the invention the random vector for encoding one of the bits is determined by generating a candidate random vector and by calculating the scalar product of the candidate random vector and the reference data vector. In case the absolute value of the scalar product is (i) above a pre-defined threshold value and (ii) the sign of the scalar product corresponds to the bit to be encoded, the candidate random vector is accepted for encoding of the bit and stored. In case the candidate random vector does not fulfil these two requirements (i) and (ii) another candidate random vector is generated and the conditions are tested again. This procedure continues until a candidate random vector is identified that fulfils both conditions.

In accordance with a further preferred embodiment of the invention a running index of the accepted candidate random vector is stored rather than the complete candidate random vector. The combination of the running index and the seed value of the pseudo random number generator that is used for generating of the random vectors unequivocally identifies the complete random vector. This way the size of the result of the encryption can be reduced drastically.

In accordance with a further preferred embodiment of the invention a data file is encrypted. For example a user can encrypt a data file on his or her computer on the basis of the authentication object in order to protect the data file against unauthorised access.

In accordance with a further preferred embodiment of the invention a user's personal data, such as the user's name as printed on his or hers passport or chip card, is encrypted. This is useful for checking the authenticity of the passport or chip card.

In accordance with a further preferred embodiment of the invention a symmetric key is encrypted on the basis of the reference object. For example, the symmetric key is used for encryption of a large data file. The symmetric key itself is encrypted in accordance with a method of the present invention on the basis of the authentication object. This way the symmetric key is protected in a secure way while avoiding the disadvantages of prior art key management approaches.

In another aspect the present invention provides a method of encrypting and decrypting binary data. The binary data is assigned a random vector for each encoded bit. The decoding is performed by acquiring a reference data vector from a reference object. The decryption of one of the bits is performed on the basis of one of the random vectors and the reference data vector.

In accordance with a preferred embodiment of the invention the decryption of one of the bits is performed by determining the sign of the scalar product of the reference data vector and the one of the random vectors.

Decryption of the encrypted binary data is only possible if the reference object is authentic. It is to be noted that the reference data vector that was used for the encryption does not need to be reproduced in an exact way for the decryption; some degree of error in the acquisition of the reference data vector is allowed without negatively affecting the decryption.

The present invention is particularly advantageous in that it facilitates the solution of the prior art key management problem in a user friendly, convenient and yet secure way. The present invention can be used in various fields for the purposes of protecting the confidentiality of data and for the purpose of authentication of documents or files.

In another aspect the present invention relates to copy protection. In accordance with a preferred embodiment of the invention the mass data to be stored on a data carrier, such as an optical recording device, e.g. a CD or DVD, is first encoded by means of a symmetric key before it is stored on the data carrier. A reference object is attached to the data carrier or forms an integral part of the data carrier such that the reference object cannot be removed without destroying the object and/or the data carrier.

The symmetric key that was used for encrypting the mass data stored on the data carrier is encrypted by means of a reference data vector acquired from the reference object of the data carrier. The resulting set of random vectors is stored on the data carrier. This can be done by attaching a label, such as a bar code label to the data carrier or a data carrier cover, and/or by digitally storing the set of random vectors on the data carrier. Depending on the implementation the seed value that was used for generating the random vectors together with the running indices is stored rather than the complete random vectors.

In accordance with a further preferred embodiment of the invention an image of the object is acquired in a read position. The read position may be dislocated from a reference position defined by markers on the object due to mechanical tolerances of the read apparatus. The amount of the dislocation of the read position with respect to a reference position is measured by detecting of the marker positions in the image. Next a projective transformation is performed on the image for compensation of the dislocation.

### BRIEF DESCRIPTION OF THE DRAWINGS

In the following, preferred embodiments of the invention will be described, by way of example only, and with reference to the drawings, in which:

FIG. 1 is illustrative of a first embodiment of an authentication label,

FIG. 2 is illustrative of a second embodiment of an authentication label,

FIG. 3 is a flow chart for generating an authentication code for an authentication label,

FIG. 4 is a flow chart for generating an authentication code by encrypting binary data,

FIG. 5 illustrates the result of the encryption of FIG. 4,

FIG. 6 is a flow chart for generating the authentication code by means of a pseudo random number generator,

FIG. 7 is a block diagram of an image processing and encoding apparatus for generating an authentication code for an authentication label,

FIG. 8 is illustrative of a grid that is used for filtering an image,

FIG. 9 is a flow diagram for determining the authenticity of an authentication label,

FIG. 10 is a flow diagram for determination of the authenticity of an authentication label by decrypting the binary data,

FIG. 11 is a flow diagram for performing the method of FIG. 10 by means of a pseudo random number generator,

FIG. 12 is illustrative of a method for determining if the authentication label has a three-dimensional pattern of distributed particles,

FIG. 13 is illustrative of an alternative method for determining if the authentication label has a three-dimensional pattern of distributed particles,

FIG. 14 is illustrative of a further alternative method for determining if the authentication label has a three-dimensional pattern of distributed particles,

FIG. 15 shows an optical recording medium with an attached or integrated authentication label,

FIG. 16 shows a block diagram of a reader for the optical recording medium of FIG. 15.

### DETAILED DESCRIPTION

FIG. 1 shows authentication label 100. Authentication label 100 has carrier layer 102 with embedded particles 104. The particles 104 are randomly distributed with carrier layer 102, such that the positions of the particles 104 within carrier layer 102 define a random three-dimensional pattern.

Carrier layer 102 consists of a translucent or transparent material, such as a synthetic resin or transparent plastic material, which enables to optically determine the positions of particles 104. For example, carrier layer 102 has a thickness 106 of between 0.3 to 1 mm or any other convenient thickness.

Particles 104 can be glass beads or balls, or disks, metallic or pearlescent pigments with or without a light reflecting coating or any other convenient form or type of particle. The particles can be optically detected due to their reflective coating, or in the absence of such reflective coating, due to their reflection coefficient, which is different to the material of the carrier layer 102.

Preferably particles 104 are 5 to 200 micrometers in diameter. For example, particles 104 can be optical lens elements or other particles to provide the authentication label 100 with a retroreflective effect.

Preferably authentication label has adhesive layer 108 in order to glue authentication label 100 to a product of document. The material properties of carrier layer 102 and adhesive layer 108 are chosen such that an attempt to remove authentication label 100 from the product or document would result in destruction of authentication label 100.

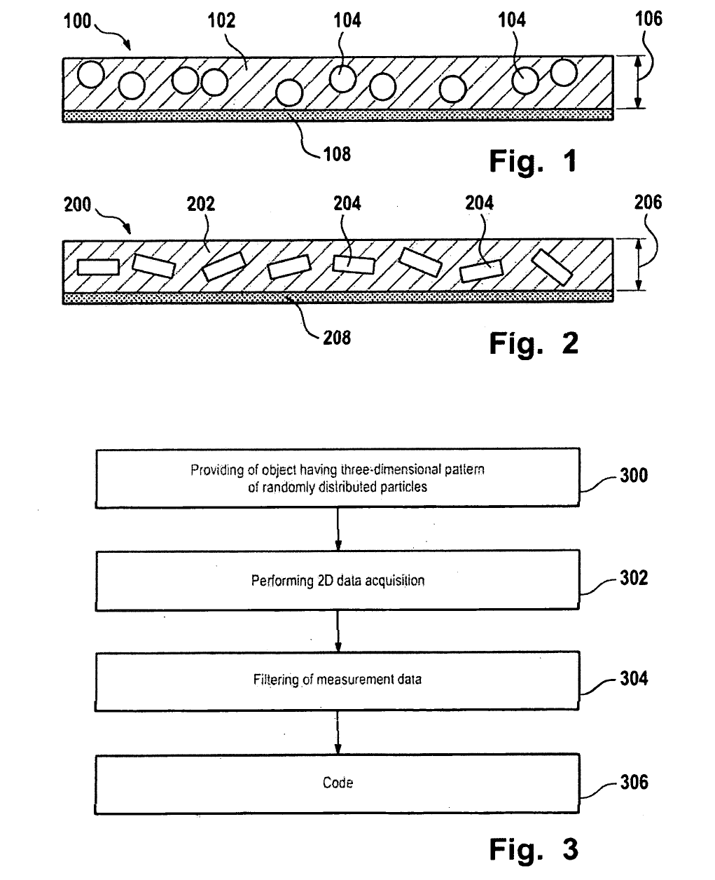

FIG. 2 shows an alternative embodiment, where like reference numerals are used to designate like elements as in FIG. 1. In the embodiment of FIG. 2 particles 204 within carrier layer 202 of authentication label 200 are metallic or pearlescent pigments. Again the thickness 206 of carrier layer 202 is about 0.3 to 1 mm or any other convenient thickness.

For example, authentication label 200 has the size of a post stamp, which is 3×4 mm and contains about two hundred particles 204. The random distribution of the two hundred particles within carrier layer 202 provides a sufficient uniqueness of authentication label 200.

FIG. 3 shows a flow chart for generating an authentication code on the basis of an authentication object, such as an authentication label as described in FIGS. 1 and 2.

In step 300 an authentication object having a three-dimensional pattern of randomly distributed particles is provided. For example, the authentication object is a piece of scotchlite tape, which is commercially available from 3M.

In step 302 a two-dimensional data acquisition step is performed. This can be done by acquiring a two-dimensional image of a surface of the authentication object. Alternatively the authentication object is scanned in two-dimensions by other measurement means. For example, if the particles that are distributed in the object are magnetic a magnetic head can be used for performing the two-dimensional data acquisition.

The measurement data that results from the two dimensional data acquisition performed in step 302 is filtered in step 304. Preferably the measurement data are low pass filtered. For example, measurement data acquired from the same region of the surface of the authentication object are averaged. These regions are predetermined by a virtual grid.

In step 306 the authentication code is provided.

In order to perform an authentication of the authentication object, steps 300 to 306 are performed again. The object is authentic if the following two conditions are fulfilled,
(i) the particles are randomly distributed in three dimensions within the object, and
(ii) the resulting codes are identical.

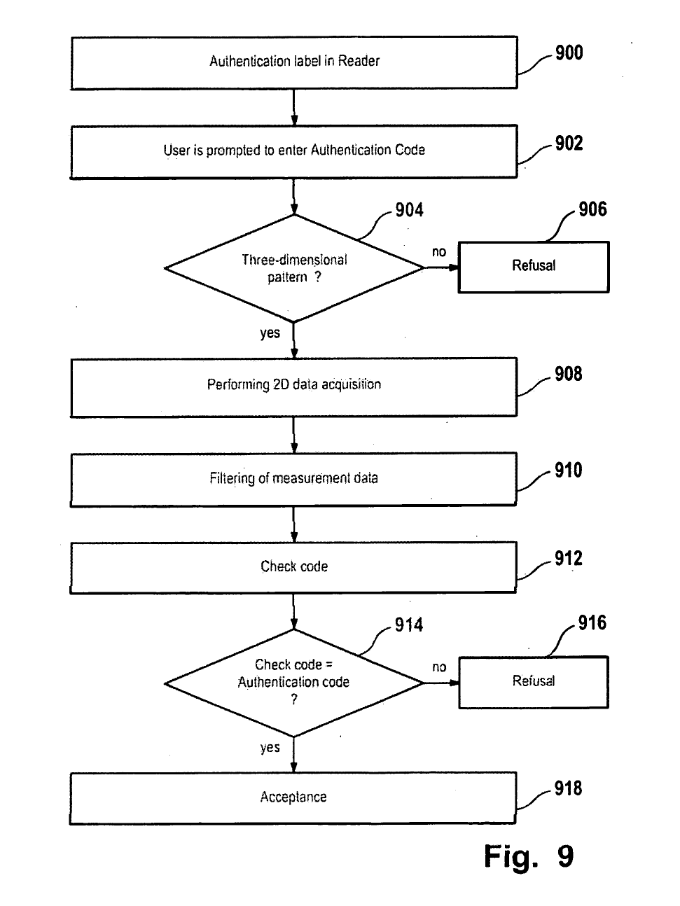

This will be explained in greater detail below by making reference to FIG. 9.

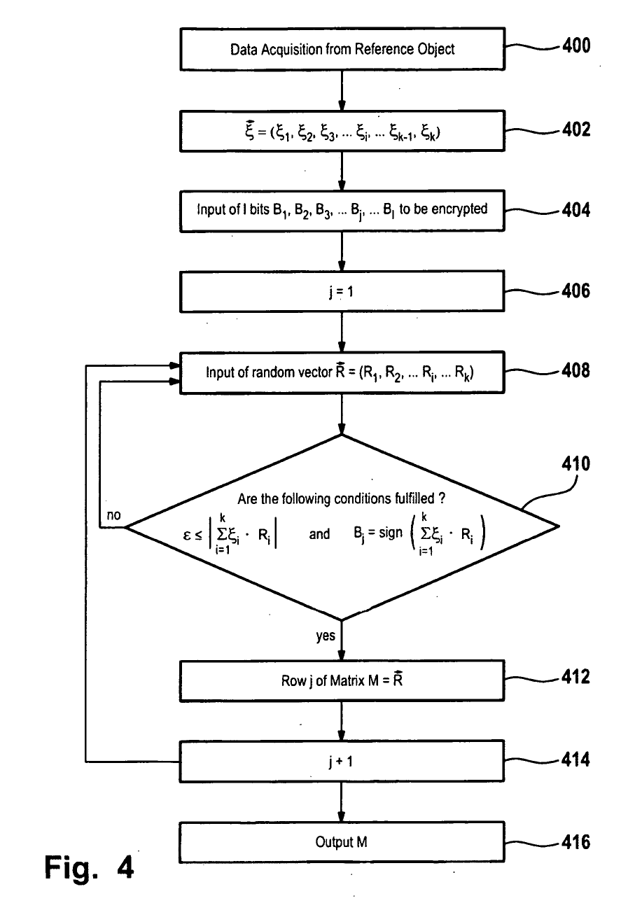

FIG. 4 shows an alternative flow chart for providing the authentication code. The authentication code is provided by encryption of l bits of binary data B₁, B₂, B₃, . . . , Bⱼ, . . . Bᵢ. A reference authentication object, such as an authentication label as described in FIGS. 1 and 2, is used as a basis for the encryption.

Depending on the kind of reference object a data acquisition step is performed (step 400). This way the reference data vector \vec{ξ} is obtained (step 402) that has a number of k values obtained from the reference data object. Preferably there is some kind of filtering of the raw data acquired from the reference object in order to provide the reference data vector \vec{ξ}. For example, the raw data is filtered by a low pass filter for increased robustness of the encoding and decoding method.

Further, it is useful to normalize the data vector data vector \vec{ξ}. This way all values εᵢ are within a defined range, such as between [−1; 1].

In step 404 the l bits to be encrypted are entered. In step 406 the index j is initialised. In step 408 a first candidate random vector \vec{R} is generated by means of a random number generator. The random vector \vec{R} has the same dimension k as the reference data vector \vec{ξ}.

In step 410 the scalar product of the reference data vector and the candidate random vector is calculated. If the absolute value of this scalar product is above a predefined threshold level ε a first condition is fulfilled. If the sign of the scalar product matches the bit Bⱼ to be encoded this means that the candidate random vector can be accepted for encoding of bit Bⱼ.

For example of the bit Bⱼ is ‘0’ the sign of the scalar product needs to be ‘−’ and if Bⱼ=1 then the sign of the scalar product needs to be ‘+’.

In other words the candidate random vector \vec{R} is accepted for encrypting bit Bⱼ if both of the following conditions are met:

$$\begin{matrix}ɛ \leq \vert {\sum }_{i = 1}^{k} {ξ}_{i} \cdot {R}_{i} \vert \\ and & ( i ) \\ {B}_{j} = sign ( {\sum }_{i = 1}^{k} {ξ}_{i} \cdot {R}_{i} ) & ( ii )\end{matrix}$$

If one of the conditions (i) and (ii) is not fulfilled the control goes back to step 408 for generation of a new candidate random vector which is then tested against the two conditions (i) and (ii) in step 410. Steps 408 and 410 are carried out repeatedly until a candidate random vector has been found that fulfils both of the conditions of step 410. The accepted candidate random vector constitutes row j of matrix M (step 412). In step 414 index j is implemented and the control goes back to step 408 for encoding of the next bit Bⱼ of the l bits to be encrypted.

After encryption of all l bits the control goes to step 416 where the matrix M is outputted as a result of the encryption.

It is to be noted that the choice of threshold ε is a trade off between security, measurement tolerance and processing time. Increasing ε increases the average number of attempts for finding an acceptable candidate random vector but also increases the acceptable measurement tolerance. Decreasing ε increases the security level and decreases the processor power requirement, but decreases the acceptable measurement tolerance. A convenient choice for ε is 1, 2, 3, 4, 5, or 6, preferably between 3 and 4, most probably ε=3.7 if the reference data vector dimension (k) is 256 and the required measurement tolerance is 5%.

In any other cases a good choice for ε is
ε=8*T*sqrt(k/3)
where T is the required measurement tolerance (5% is T=0.05) and k is the reference data vector dimension and sqrt( ) function is the normal square root function.

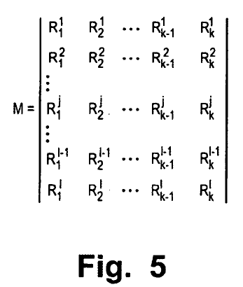

FIG. 5 shows the resulting matrix M that has a number of l rows and k columns. Each row j of matrix M is assigned to one of the bits Bⱼ and contains the random vector that encodes the respective bit Bⱼ.

Decryption of matrix M in order to recover the encrypted bits is only possible if the decryptor is in the possession of the reference object that was used for the encryption (cf. Step 400 of FIG. 4) as the reference data vector is not stored in the matrix \vec{ξ} or elsewhere.

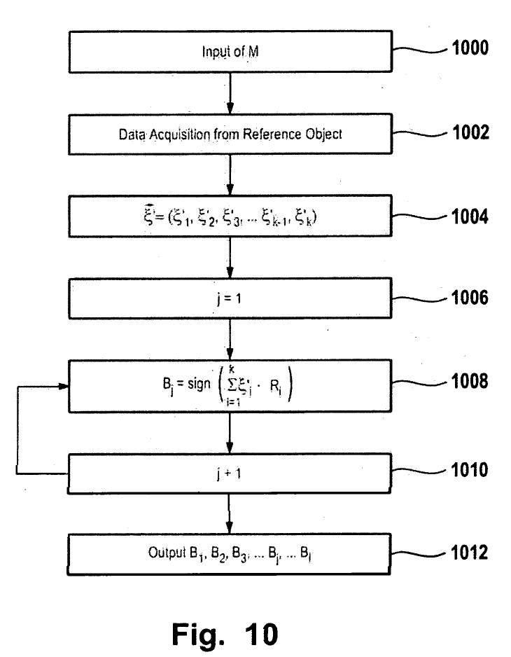

A corresponding decryption method is explained in greater detail below by making reference to FIG. 10.

For example, the resulting matrix M is stored by printing a bar code on a secure document carrying the authentication object. Alternatively or in addition the matrix M can also be stored electronically in case the secure document has an electronic memory.

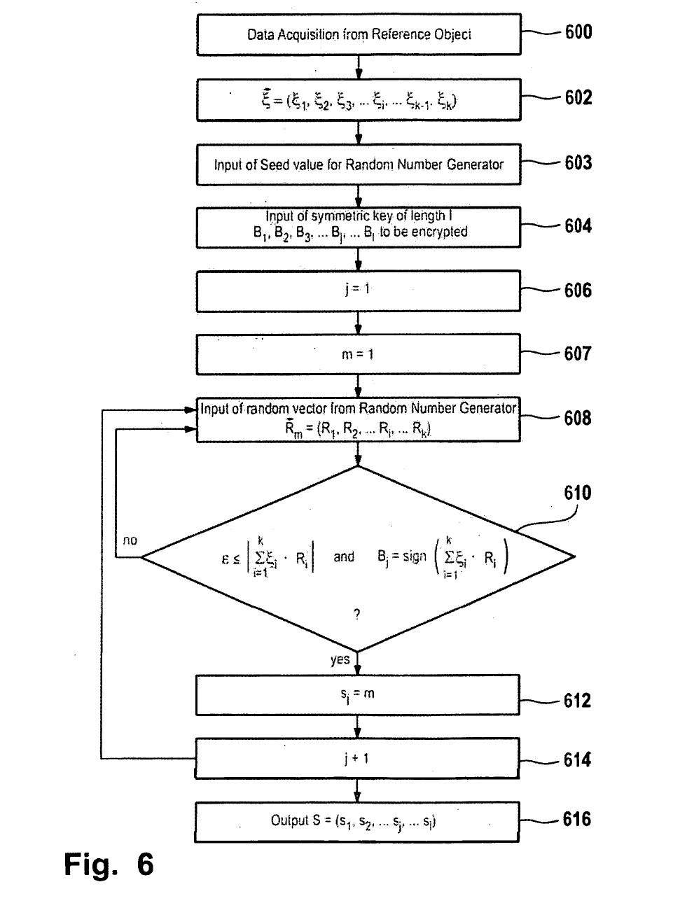

FIG. 6 shows a preferred embodiment of the encryption method of FIG. 4 that enables to compress the result of the encryption operation. Steps 600 and 602 are identical to steps 400 and 402 of FIG. 4. In step 603 a seed value for the pseudo random number generator is entered. In step 604 a symmetric key having a length l is entered. This corresponds to step 404 of FIG. 4. In addition to the initialisation of index j in step 606 (corresponds to step 406 of FIG. 4) index m is initialised in step 607. Index m is the running index of the random number generator.

In step 608 the first random vector \vec{R}ₘ₌₁ of k random numbers Rᵢ is generated by the pseudo random number generator on the basis of the seed value. This candidate random vector is evaluated in step 610 in the same way as in step 410 of FIG. 4. In case the candidate random vector \vec{R}ₘ₌₁ is accepted as it fulfils the conditions of step 610 only the running index m is stored in step 612 as an element of the sequence S that results from the encryption.

Step 614 corresponds to step 414. In step 616 the sequence S containing a number of l running indices is outputted rather than a matrix M having a number of l×k random numbers. Hence, by storing the running indices and the seed value rather than the random vectors themselves a drastic compression of the result of the encoding operation is obtained.

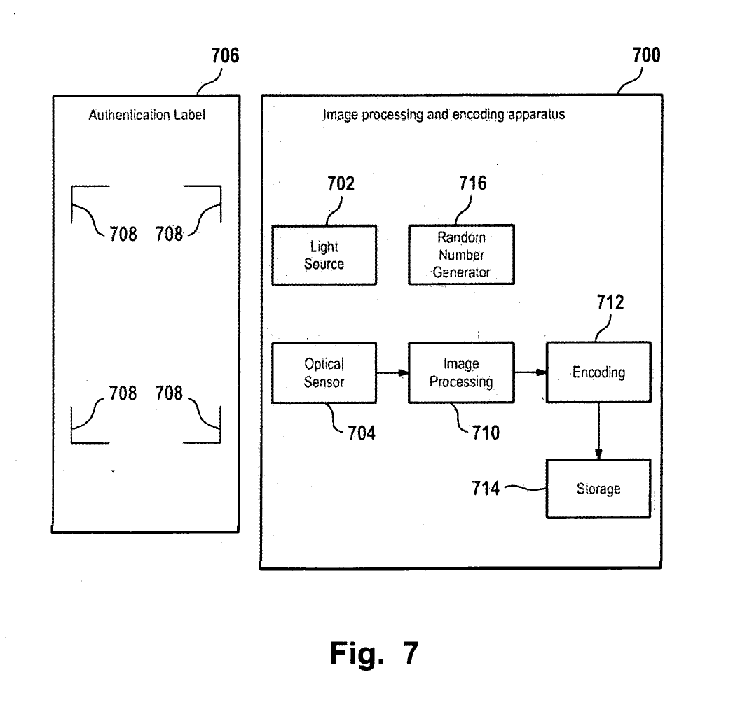

FIG. 7 shows a block diagram of an image processing and encoding apparatus 700. Image processing and encoding apparatus 700 has light source 702 and optical sensor 704 for taking an image of authentication label 706. For example, authentication label 706 has a similar design as authentication label 100 (cf. FIG. 1) and authentication label 200 (cf. FIG. 2). In addition, authentication label 706 has position markers 708 that relate authentication label 706 to a reference position.

Optical sensor 704 is coupled to image processing module 710. Image processing module 710 has an image processing program that can filter the image data required by optical sensor 704.

Image processing module 710 is coupled to encoding module 712. Encoding module 712 receives the filtered measurement data from image processing module 710. Encoding module 712 is coupled to a storage 714 in order to store the result of the encoding for later usage. For example, the image processing and encoding is done for a sequence of authentication labels for the purpose of mass production of data carriers, passports, bank cards, or other secure documents.

In this case a sequence of authentication codes is stored in storage 714 during the mass production. These authentication codes can be printed and mailed to the users independently from the mailing of the authentication labels 706. For example, the authentication label 706 are attached to customer cards or financial transaction cards, such as ATM-cards, that are mailed to the customers. The customers receive the corresponding authentication codes by separate mail.

Preferably image processing and encoding apparatus 700 has random number generator 716. Preferably random number generator 716 is a pseudo random number generator.

Preferably image processing module 710 delivers reference data vector \vec{ξ} (cf. step 402 of FIG. 4 and step 602 of FIG. 6). Encoding module 712 performs steps 406 to 416 of FIG. 4, or if random number generator 716 is a pseudo random number generator, steps 606 to 616 of FIG. 6. The resulting matrix M or sequence S is stored in storage 714.

As a matter of principle the l bits B₁, B₂, B₃, . . . Bₗ that are encrypted by encoding module 712 can be of any kind. For example the ASCII code of a user name or other personal data is encrypted. Alternatively a random number such as a pin code that is only known by the user is encrypted.

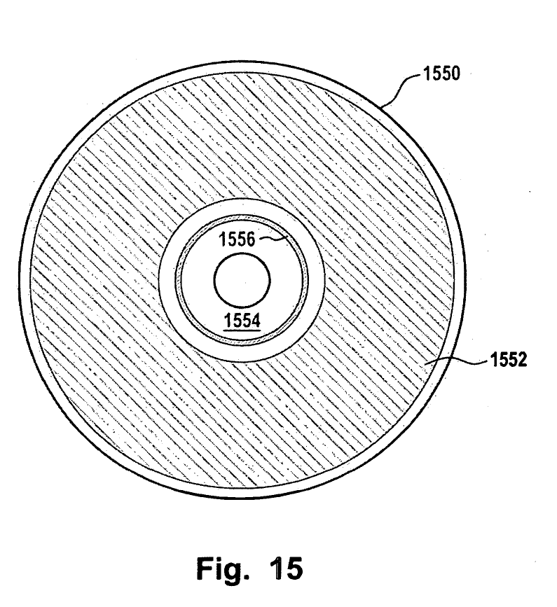

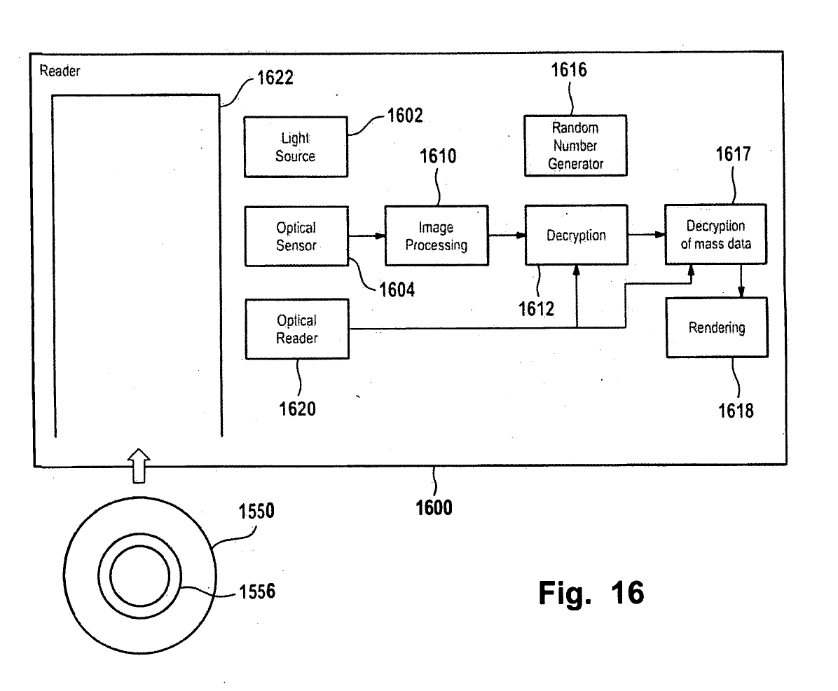

As a further alternative a symmetric key is encrypted. The symmetric key is used for encryption of mass data stored on a data carrier. Decryption of the mass data is only possible by an authorised user who is in possession of the authentication label 706 and matrix M or sequence S depending on the implementation. The later application is particularly useful for the purpose of copy protection as it will be explained in greater detail below by making reference to FIGS. 15 and 16.

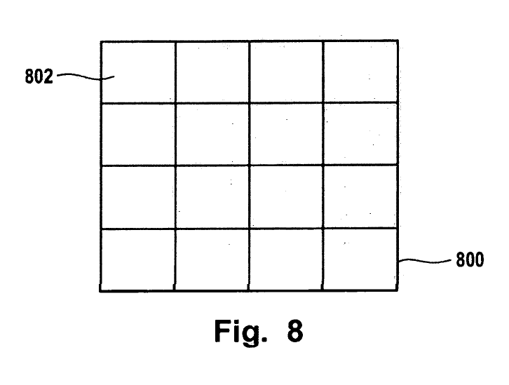

FIG. 8 shows grid 800 that has grid elements 802. Grid 800 can be used by image processing module 710 (cf. FIG. 7) for the purpose of filtering image data acquired by optical sensor 704. For example image processing module 710 calculates a normalised average grey value for each one of the grid elements 802. The normalised and averaged grey values provide the reference data vectors \vec{ξ} for the encryption and \vec{ξ} for the decryption. It is to be noted that various other image processing and filtering procedures can be employed to provide the reference data vectors on the basis of the image data acquired by optical sensor 704.

FIG. 9 shows an authentication method that is based on an authentication object or label (cf. FIGS. 1 and 2) as explained above, in particular with reference to FIGS. 1, 2 and 3. In step 900 e.g. an authentication card with an attached authentication label is inserted into a card reader. In step 902 the user is prompted to enter his or hers authentication code into the card reader, e.g. the code provided in step 306 of FIG. 3.

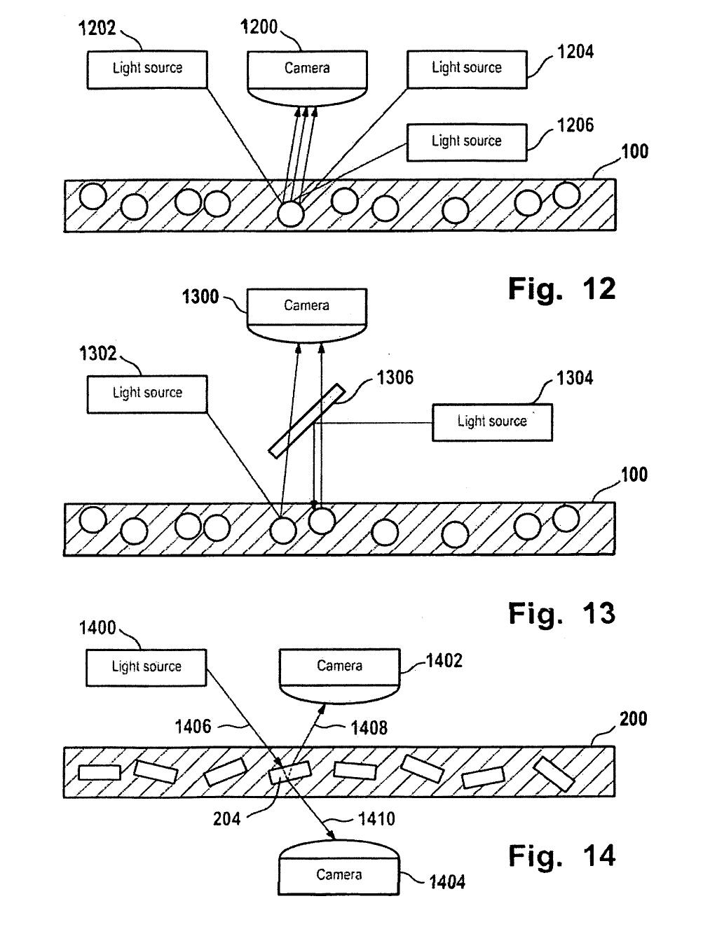

In step 904 the card reader makes a determination whether the authentication label has a three-dimensional pattern of particles or not. This can be done by various methods. Preferred embodiments of how this determination can be done will be explained in more detail by making reference to the FIGS. 12, 13 and 14 below.

If it is determined in step 904 that there is no three-dimensional pattern of distributed particles in the authentication label, a corresponding refusal message is outputted by the card reader in step 906.

If the contrary is true, the authentication procedure goes on to step 908, where a two-dimensional data acquisition procedure on the authentication label is performed. As it has been determined before that there is in fact a three-dimensional distribution pattern of the particles it is sufficient to acquire the data from the authentication label in only two dimensions.

In step 910 the measurement data obtained from the data acquisition performed in step 908 is filtered to provide a check code in step 912. It is to be noted that steps 908 to 912 are substantially identical to steps 302 to 306 of FIG. 3. In case the authentication label is authentic the check code obtained in step 912 will be identical to the code obtained in step 306. This is checked in step 914.

In case the codes are not identical a refusal message is outputted by the card reader in step 916. If the codes are in fact identical an acceptance message is outputted in step 918 by the card reader. Alternatively an action is performed or enabled depending on the field of application of the authentication method, such as banking, access control, financial transaction, or copy protection.

FIG. 10 illustrates a decryption method that corresponds to the encryption method of FIG. 4.

In step 1000 the matrix M is entered. In step 1002 data is acquired from the reference object. On this basis the reference data vector \vec{ξ′} is obtained (step 1004). It is to be noted that the data acquisition step 400 of FIG. 4 and data acquisition step 1002 of FIG. 10 are substantially identical. However, in case the reference object is a physical object the data acquisition will involve some kind of measurement error.

As a consequence the raw data obtained from the measurements of the reference object will not be exactly the same in step 400 FIG. 4 and step 1002 of FIG. 10. As a consequence reference data vector \vec{ξ′} provided in step 1004 will also not be identical to reference data vector \vec{ξ} provided in step 402 of FIG. 4. Despite such differences between the reference data vector that was used for the encoding and the reference data vectors' that forms \vec{ξ} the basis of the decoding, a correct decoding of the matrix \vec{ξ′} can be performed in order to obtain the ‘hidden’ bits B₁ . . . Bⱼ, . . . Bₗ:

In step 1006 the index j is initialised. In step 1008 the scalar product of the reference data vector \vec{ξ′} and the random vector in row j of matrix M that is assigned to bit Bⱼ is calculated. The sign of the scalar provides the decoded bit value Bⱼ whereby the same convention as for the encoding is used. In other words, when the sign is negative, the bit value is ‘0’; if the sign is positive the bit value Bⱼ is ‘1’.

In step 1010 the index j is incremented and the control goes back to step 1008 for decoding the next bit position. Steps 1008 and 1010 are carried out repeatedly until all l bit positions have been decoded. The decoded l bits are outputted in step 1012.

It is to be noted that the above described encryption and decryption methods are particularly advantageous as they are error tolerant in view of unavoidable measurement errors in the data acquisition from the reference object. Typically the reference data vectors used for the encryption and for the decryption will not be exactly the same but still a correct decryption result is obtained with a high degree of reliability and security.

In case the decoded l bits outputted in step 1012 are identical to the original bits that have been inputted in step 404 (cf. FIG. 4) the reference object is authentic, otherwise the reference object is refused.

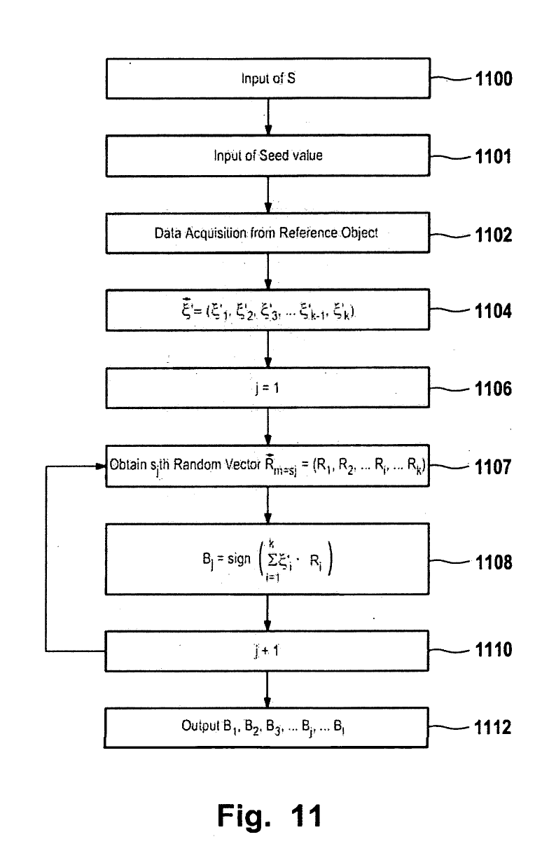

FIG. 11 shows an alternative decryption method that is based on pseudo random vectors. The decryption method of FIG. 11 corresponds to encryption method of FIG. 6.

In step 1100 the sequence S is inputted. The seed value that was used for the encoding (cf. step 603 of FIG. 6) is inputted in step 1101. Steps 1102, 1104, 1106 are substantially identical to the corresponding steps 1002, 1004 and 1006 of FIG. 10.

In step 1107 a pseudo random generator that operates in accordance with the same algorithm as the pseudo random number generator that has been used for the encryption is used to recover the random vector \vec{R}ₘ₌ₛ_{ⱼ} based on the seed value entered in step 1101. This way the random vector that is represented by the running index sⱼ in the sequence S is recovered.

The following step 1108 is identical to step 1008 of FIG. 10. In step 1110 the index j is incremented. From there the control returns to step 1107 for recovery of the consecutive random vector having the running index sⱼ. In step 1112 the result of the decoding is outputted.

FIG. 12 shows authentication label 100 (cf. FIG. 1). In order to determine whether there is a three-dimensional pattern of particles within authentication label 100 or not three images of authentication label 100 are taken in a sequence by means of camera 1200. The first image is taken with diffuse light source 1202 switched on and diffuse light sources 1204 and 1206 switched off.

The second image is taken with light sources 1202 and 1206 switched off, while light source 1206 illuminates authentication label 100 from still another illumination angle.

The three images are combined to provide a resulting image. The combination can be done by digitally superimposing and adding the digital images. If there is in fact a three-dimensional distribution pattern of particles within authentication label regular geometric artefacts must be present in the resulting image. Such artefacts can be detected by a pattern recognition step. In the case of three light sources the geometric artefacts, which are produced, are triangles of similar size and shape. This effect is not reproducible by means of a two-dimensional copy of the original authentication label 100.

As an alternative, more than three light sources at different illumination angles can be used for taking a corresponding numbers of images, which are superposed and added. Changing the number of light sources also changes the shape of the geometric artefact in the resulting image.

FIG. 13 shows an alternative method for determining the three-dimensionality of the distribution pattern of the particles within authentication label 100. For this application is required, that authentication label 100 is reflective. The underlying principle is that the reflective effect can not be reproduced by means of two-dimensional copy of the authentication label 100.

The test, whether authentication label 100 is in fact reflective or not, is done as follows: a first image is taken by camera 1300 with diffuse light source 1302 switched on. The diffuse light source 1302 will not invoke the reflective effect. The second image is taken with diffuse light source 1302 switched off and direct light source 1304 switched on.

By means of half mirror 1306 this produces an incident light beam, which is about perpendicular to the surface of authentication label 100. This light beam invokes the reflective effect. By comparing the first and the second images it is apparent whether authentication label 100 is reflective or not. This distinction can be made automatically by means of a relatively simple image processing routine.

FIG. 14 shows a further alternative method of determining whether the distribution pattern of particles is three-dimensional or not. This method requires that the particles within authentication label 200 (cf. FIG. 2) are pearlescent pigments.

Presently, mica pigments coated with titanium dioxide and/or iron oxide are safe, stable and environmentally acceptable for use in coating, cosmetics and plastics. The pearlescent effect is produced by the behaviour of incident light on the oxide coated mica; partial reflection from and partial transmission through the platelets create a sense of depth. The colour of the transmitted light is complementary to the colour of the reflected light.

To check the presence of this colour effect, light source 1400 producing diffuse, white light and two cameras 1402 and 1404 are used. The cameras 1402 and 1404 are positioned at opposite sides of authentication label 200.

An incident light beam 1406 is partly reflected by particle 204 into reflected light beam 1408 and partly transmitted as transmitted light beam 1410. If the colours of reflected light beam 1408 and transmitted light beam 1410 are complementary this means that authentication label 200 could not have been produced by two-dimensional copying.

The test whether the colours of reflected light beam 1408 and transmitted light beam 1410 are complementary can be made by summing the colour coordinate values e.g. using the RGB colour coordinate system. The summation of the colour coordinates must result in roughly a constant RGB value.

FIG. 15 shows optical disc 1550, such as a CD or DVD. Optical disc 1550 has an area 1552 that is covered by a data track. Outside area 1552, such as within an area 1554, an angularly shaped authentication label 1556 is glued to the surface of optical disc 1550 or integrated within optical disc 1550. Authentication label 1556 is similar to authentication label 100 of FIG. 1 or authentication label 200 of FIG. 2.

The data track of area 1552 stores encrypted data, such as audio and/or video data, multimedia data, and/or data files. In addition matrix M (cf. step 416 of FIG. 4) or sequence S (cf. step 616 of FIG. 6) and the seed value are stored in the data track without encryption. Alternatively a machine readable and/or human readable label is attached to optical disc 1550 with the matrix M or sequence S and seed value printed on it. Preferably the label is glued to the back side of optical disc 1550 or within inner area 1554.

When a user desires to use optical disc 1550, he or she puts optical disc 1550 into a player or disc drive. The player or disc drive reads the matrix M or the sequence S and seed value from the optical disc 1550. On this basis the authenticity of authentication label 1656 is checked by performing the method of FIG. 10 or 11, depending on the implementation. In case authentication label 1556 is in fact authentic the symmetric key is recovered and the encrypted mass data stored in the data track is decrypted in order to enable playback, rendering or opening of the files. Otherwise the key is not recovered and decryption of the mass data is not possible.

FIG. 16 shows a block diagram of reader 1600 that can be used as a playback device for optical disc 1550 (cf. FIG. 15). Elements of FIG. 15 that correspond to elements of FIG. 7 are designated by like reference numerals.

Reader 1600 has slot 1622 with a mechanism for insertion of optical disc 1550. Authentication label 1556 is attached to the surface of optical disc 1550 by an adhesive or it is integrated within the card. In the latter case the surface of optical disc 1550 must be transparent in order to enable to take an image of the surface of authentication label 1556. For example, optical disc 1550 is made of a flexible, transparent plastic that has a smooth outer surface and which envelops authentication label 1556.

Reader 1600 has at least one light source 1602 for illumination of authentication label 1556 when optical disc 1550 is inserted into slot 1622 (cf. the implementations of FIG. 12 to 14).

Further, reader 1600 has optical sensor 1604, such as a CCD camera. Optical sensor 1604 is coupled to image processing module 1610. Image processing module 1610 is equivalent to image processing module 710 of FIG. 7, i.e. it provides the same kind of two-dimensional data acquisition and filtering.

Image processing module 1610 is coupled to decryption module 1612. Decryption module 1612 serves to recover a symmetric key for decryption of mass data stored on optical disc 1550 by consecutive decryption module 1617. Decryption module 1617 is coupled to rendering module 1618.

Optical reader 1620 is coupled both to decryption module 1612 and decryption module 1617. Optical reader 1620 has a laser diode for directing a laser beam onto a surface of optical disc 1550 in order to read its data track.

If the method of FIG. 6 has been used for the encoding pseudo random number generator 1616 is required for the decryption.

Preferably light source 1602 and optical sensor 1604 implement any one of the arrangements of FIGS. 12 to 14 as explained above.

In the following it is assumed that the matrix M or the sequence S and seed code are stored on the data track of optical disc 1550.

In operation optical disc 1550 is inserted into slot 1622. In response a determination is made by image processing module 1610 by means of light source 1602 and optical sensor 1604 where there is a three-dimensional distribution of particles within authentication label 1556 (cf. FIGS. 12, 13 and 14).

If image processing module 1610 determines that there is in fact a three-dimensional particle distribution within authentication label 1556 it directs optical reader 1620 to read matrix M or sequence S and the seed value from the data track of the optical disc 1550. This information is entered into decryption module 1612.

Further, optical sensor 1604 acquires image data from authentication label 1556. The image data is filtered by image processing module 1610 and the resulting data vector \vec{ξ′} is entered into decryption module 1612. Decryption module 1612 recovers the symmetric key from the matrix M or the sequence S by using the seed value for the random number generator 1616. The resulting symmetric key is provided to decryption module 1617. The encrypted mass data that is read by optical reader 1620 from optical disc 1550 is decrypted by decryption module 1617 by means of the symmetric key. As a result the decrypted mass data is recovered and rendered by rendering module 1618.

Alternatively, the matrix M or the sequence S and the seed value are provided to the user by means of a separate information carrier, such as on a printed document. In this implementation the user may need to manually enter the matrix M or the sequence S and the seed value into reader 1600. Alternatively, the information carrier is machine readable and attached to optical disc 1550. In this case the information carrier is read by means of optical sensor 1604 and image processing module 1610 in order to provide matrix M or sequence S and the seed value to the decryption module 1612.

### LIST OF REFERENCE NUMERALS

100 Authentication Label
102 Carrier Layer
104 Particles
106 Thickness
108 Adhesive Layer
200 Authentication Label
202 Carrier Layer
204 Particles
206 Thickness
208 Adhesive Layer
700 Image Processing and Encoding Apparatus
702 Light Source
704 Optical Sensor
706 Authentication Label
708 Position Makers
710 Image Processing Module
712 Encoding Module
714 Storage
716 Random Number Generator
800 Grid
802 Grid Element
1200 Camera
1202 Light Source
1204 Light Source
1206 Light Source
1300 Camera
1302 Diffuse Light Source
1304 Direct Light Source
1306 Half Mirror
1401 Light Source
1402 Camera
1404 Camera
1406 Light Beam
1408 Reflected Light Beam
1410 Transmitted Light Beam
1550 Optical Disk
1552 Area
1554 Inner Area
1556 Authentication Label
1600 Reader
1550 Optical Disk
1552 Area
1554 Inner Area
1556 Authentication Label
1600 Reader
1602 Light Source
1604 Optical Sensor
1610 Image Processing Module
1612 Decryption Module
1616 Random Number Generator
1617 Decryption Module
1618 Rendering Module
1620 Optical Reader
1622 Slot

1. A method of determining the authenticity of an object comprising:
receiving a first code,
determining if the object has a three-dimensional pattern of distributed particles,
performing a two-dimensional data acquisition for acquisition of a second code from the object,
determining the authenticity using the first and second codes.

2. The method of claim 1, the determination if the object has a three-dimensional pattern of distributed particles being performed by:
acquiring a first image of the object with a first angle of illumination,
acquiring a second image of the object with a second angle of illumination,
combining the first and second images,
determining if a geometrical pattern is present in the combined images.

3. The method of claim 1, wherein the determination if the object has a three-dimensional pattern of distributed particles is made by determining if the object is reflective.

4. The method of claim 3, wherein it is determined whether the objective is reflective by acquiring a first image of the object with diffused illumination and acquiring a second image of the object with direct illumination and comparing a brightness of the object in the first and second images.

5. The method of claim 1, the determination if the object has a three-dimensional pattern of distributed particles being performed by:
illuminating the object with diffused, white light,
detecting light reflected from the object and light transmitted through the object,
determining if the reflected light and the transmitted light have complimentary colours.

6. The method of claim 1, further comprising:
acquiring an image of the object in a read position,
determining a dislocation of the read position with respect to a reference position by detecting of marker positions in the image,
performing a projective transformation of the image for compensation of the dislocation.

7. The method of claim 1, further comprising filtering of measurement data acquired by the two-dimensional data acquisition in order to provide the second code, wherein the filtering involves low pass filtering of the measurement data.

8. The method of claim 1, the first code comprising a set of random vectors and the second code being a data vector.

9. The method of claim 8, the random vectors being pseudo random, each random vector being represented by a running index, and further
comprising entering a seed value for a pseudo random number generator in order to generate the random vectors on the basis of the seed value.

10. The method of claim 8, further comprising determining the signs of scalar products of each one of the random vectors and the data vector for generating a third code.

11. The method of claim 10, the third code being a check code for comparison with an authentication code.

12. The method of claim 10, the third code being a symmetric key.

13. The method of claim 12, the object belonging to a data carrier storing an encrypted file, the method further comprising decrypting the file by means of the symmetric key.

14. The method of claim 13, the first code being stored on the data carrier.

15. A computer program product for performing a method in accordance with claim 1.

16. A logic circuit operable to perform a method in accordance with claim 1.

17. An apparatus for determining the authenticity of an object comprising:
a receiver for receiving a first code,
an optical component for determining if the object has a three-dimensional pattern of distributed particles,
a measurement component for performing a two-dimensional data acquisition for acquisition of a second code from the object,
a microprocessor for determining the authenticity on the basis of the first and second codes.

18. The apparatus of claim 17, the optical component being adapted to perform the steps of:
acquiring a first image of the object with a first angle of illumination,
acquiring a second image of the object with a second angle of illumination,
combining of the first and second images,
determining if a geometrical pattern is present in the combined images.

19. The apparatus of claim 17, the optical component being adapted to determine if the object is reflective.

20. The apparatus of claim 17, the optical component being adapted to determine whether the object is reflective by acquiring a first image with diffused illumination of the object and to acquire a second image with direct illumination of the object for comparing a brightness of the object in the first and second images.

21. The apparatus of claim 17, the optical component being adapted to perform the steps of:
illuminating the object with diffused, white light,
detecting light reflected from the object and light transmitted through the object,
determining if the reflected light and the transmitted light have complimentary colours.

22. The apparatus of claim 17, the microprocessor being adapted to perform a projective transformation in order to compensate a dislocation of the object with respect to a reference position.

23. The apparatus of claim 17, further comprising a low pass filter for filtering the data acquired by the measurement component in order to provide the second code.

24. A method for providing a first code for use in an authentication method, the method comprising:
providing a third code,
acquiring a data vector from an object representing a second code,
determining a random vector for each one of the bits of the third code on the basis of the second code to provide the first code.

25. The method of claim 24, wherein the object is an image, and further comprising scanning the image in order to obtain image data and filtering the image data to provide the data vector.

26. The method of claim 25, the filtering of the image data comprising a calculation of mean values of sub-sets of the image data.

27. The method of claim 26, the sub-sets of the image data being determined by a predefined grid.

28. A computer program product for performing a method of claim 24.

29. A logic circuit operable to perform a method of claim 24.

30. An apparatus operable to perform a method of claim 24.

31. An electronic device for determining the authenticity of an object, the electronic device comprising:
means for receiving a first code,
means for determining if the object has a three-dimensional pattern of distributed particles,
means for performing a two-dimensional data acquisition for acquisition of a second code from the object,
means for determining the authenticity on the basis of the first and second codes.

32. An apparatus for determining the authenticity of an object comprising:
a receiver for receiving a first code,
an optical component for determining if the object has a three-dimensional pattern of distributed particles,
a measurement component for performing a two-dimensional data acquisition for acquisition of a second code from the object,
a microprocessor for determining the authenticity on the basis of the first and second codes,
wherein the optical component is adapted to determine if the object is reflective.

33. An apparatus for determining the authenticity of an object comprising:
a receiver for receiving a first code,
an optical component for determining if the object has a three-dimensional pattern of distributed particles,
a measurement component for performing a two-dimensional data acquisition for acquisition of a second code from the object,
a microprocessor for determining the authenticity on the basis of the first and second codes,
wherein the optical component is adapted to
illuminate the object with diffused, white light,
detect light reflected from the object and light transmitted through the object for determining if the reflected light and the transmitted light have complimentary colours.

34. An apparatus for determining the authenticity of an object comprising:
a receiver for receiving a first code,
an optical component for determining if the object has a three-dimensional pattern of distributed particles,
a measurement component for performing a two-dimensional data acquisition for acquisition of a second code from the object,
a microprocessor for determining the authenticity on the basis of the first and second codes,
wherein the first code comprises a set of random vectors and the second code is a data vector, the random vectors being pseudo random, and further comprising a pseudo random number generator for generating the random vectors on the basis of a seed value.
